(19) United States
(12) Patent Application Publication
(10) Pub. No.: US 2009/0082031 A1
(43) Pub. Date: Mar. 26, 2009

(54) Apparatus and method for band allocation scheduling in multi-band communication system

(75) Inventors: Yung-Soo Kim, Seongnam-si (KR); Young-Sil Choi, Seoul (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 12/284,026

(22) Filed: Sep. 18, 2008

(30) Foreign Application Priority Data
Sep. 21, 2007 (KR) 2007-0096475

(51) Int. Cl. H04Q 7/20

(52) U.S. Cl. 455/452.2

(57) ABSTRACT

Provided is an apparatus and method for band allocation scheduling in a multi-band communication system. In the method, transmission (TX) signals are classified into at least one of a control signal, a broadcast signal and a signal requiring a short latency, and other user signal by considering the types of the TX signals. A band of a frequency lower than a reference frequency among the multiple bands is allocated to a signal classified as at least one of the control signal, the broadcast signal and the signal requiring a short latency. A band of a frequency higher than the reference frequency is allocated to a signal classified as the other user signal.

### CROSS-REFERENCE TO RELATED APPLICATION(S) AND CLAIM OF PRIORITY

The present application claims priority under 35 U.S.C. §119 to an application filed in the Korean Intellectual Property Office on Sep. 21, 2007 and assigned Serial No. 2007-0096475, the contents of which are incorporated herein by reference.

### TECHNICAL FIELD OF THE INVENTION

The present invention relates generally to band allocation and, in particular, to an apparatus and method for band allocation scheduling in a multi-band communication system.

### BACKGROUND OF THE INVENTION

In conventional systems, because a single band is allocated to an uplink (UL) and a downlink (DL), a traffic amount changes with time and the total traffic amount increases due to an increase in multimedia traffic, thus making it difficult to satisfy the requirements for a high data rate. Also, it is difficult to simultaneously satisfy the requirements for a high data rate and the effects of a system throughput increase due to a base station coverage extension and a cost reduction due to a decrease in the number of base stations.

Also, conventional resource allocation methods allocate resources without consideration of various conditions such as the transmission purpose of each user terminal signal, a required data rate, latency requirements, the location of a user terminal, and the mobility of a user terminal, thus failing to maximize the resource efficiency and the quality of service (QoS) of user terminals.

There is, therefore, a need in the art for techniques to maximize the resource efficiency while increasing the system throughput by simultaneously achieving the high data rate and the coverage extension.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for band allocation scheduling in a multi-band communication system.

Another object of the present invention is to provide an apparatus and method for band allocation scheduling in a multi-band communication system, which can simultaneously achieve a high data rate and a coverage extension.

Still another object of the present invention is to provide an apparatus and method for allocating resources in a multi-band communication system in consideration of some or all of various conditions such as the characteristics of each band frequency, the type and transmission purpose of a user terminal signal, a required data rate, latency requirements, the location of a user terminal, the moving speed of a user terminal, and inter-frequency load balancing.

Still another object of the present invention is to provide an apparatus and method for reducing an overhead in a multi-band communication system when multi-band MAP information is transmitted in a relatively low-frequency band among multiple bands.

Still another object of the present invention is to provide a frame structure for enabling all the user terminals to operate efficiently in a multi-band communication system when there is a mixture of user terminals capable of simultaneously decoding multiple bands and user terminals capable of decoding only one band.

According to an aspect of the present invention, a method for allocating bands in a multi-band communication system includes: classifying transmission (TX) signals into at least one of a control signal, a broadcast signal and a signal requiring a short latency, and other user signal in consideration of the types of the TX signals; allocating a band of a frequency lower than a reference frequency among the multiple bands to a signal classified as at least one of the control signal, the broadcast signal and the signal requiring a short latency; and allocating a band of a frequency higher than the reference frequency to a signal classified as the other user signal.

According to another aspect of the present invention, an apparatus for allocating bands in a multi-band communication system includes: a scheduler for classifying transmission (TX) signals into at least one of a control signal, a broadcast signal and a signal requiring a short latency, and other user signal in consideration of the types of the TX signals, allocating a band of a frequency lower than a reference frequency among the multiple bands to a signal classified as at least one of the control signal, the broadcast signal and the signal requiring a short latency, and allocating a band of a frequency higher than the reference frequency to a signal classified as the other user signal; and a MAP generator for generating MAP information containing the band allocation results.

According to still another aspect of the present invention, a method for resource indexing in a multi-band communication system including: giving a band index to each band; giving resource indexes to the entire resources in the corresponding band on a band-by-band basis; and transmitting at least one of the resource index and the band index of the corresponding resource to a user terminal allocated the resource.

According to still another aspect of the present invention, a method for resource indexing in a multi-band communication system including: giving resource indexes to the entire resources in multiple bands on a step-by-step basis; and transmitting the resource index of the corresponding resource to a user terminal allocated the resource.

According to still another aspect of the present invention, a frame structure for a multi-band communication system where there is a mixture of user terminals a single band and user terminals supporting multiple bands simultaneously, including: a frame of a band of a frequency lower than a reference frequency among the multiple bands, the lower-frequency band frame including at least one of a control signal region, a downlink data region and an uplink data region; and a frame of a band of a frequency higher than the reference frequency among the multiple bands, the higher-frequency band frame including at least one of a downlink data region and an uplink data region, wherein resources of the higher-frequency band frame are transmitted to only user terminals simultaneously supporting multiple bands in the same time interval when signals are transmitted through the control signal region of the lower-frequency band frame.

According to still another aspect of the present invention, a frame structure for a multi-band communication system where there is a mixture of user terminals a single band and user terminals supporting multiple bands simultaneously, including: a frame of a band of a frequency lower than a reference frequency among the multiple bands, the lower-frequency band frame including at least one of a control signal region, a downlink data region and an uplink data region; and a frame of a band of a frequency higher than the reference frequency among the multiple bands, the higher-frequency band frame including at least one of a downlink data region and an uplink data region, wherein all or some of the uplink data region of the higher-frequency band frame are located in the same time interval when signals are transmitted through the control signal region of the lower-frequency band frame.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating various band allocation conditions according to an embodiment of the present invention;

FIGS. 2A and 2B are diagrams illustrating a band allocation considering only the conditions of the frequency characteristics of each band and the type and transmission purpose of a user terminal signal among the various band allocation conditions according to an embodiment of the present invention;

FIG. 3 is a block diagram of a base station in a multi-band communication system according to an embodiment of the present invention;

FIG. 4 is a flow diagram illustrating a band allocation scheduling method of a scheduler in a multi-band communication system according to an embodiment of the present invention;

FIGS. 5A and 5B are diagrams illustrating a resource indexing method for reducing a MAP overhead in a multi-band communication system according to an embodiment of the present invention; and

FIGS. 6A, 6B and 6C are diagrams illustrating a frame structure designing method considering the capability of a user terminal in a multi-band communication system according to an embodiment of the present invention.

### DETAILED DESCRIPTION OF THE INVENTION

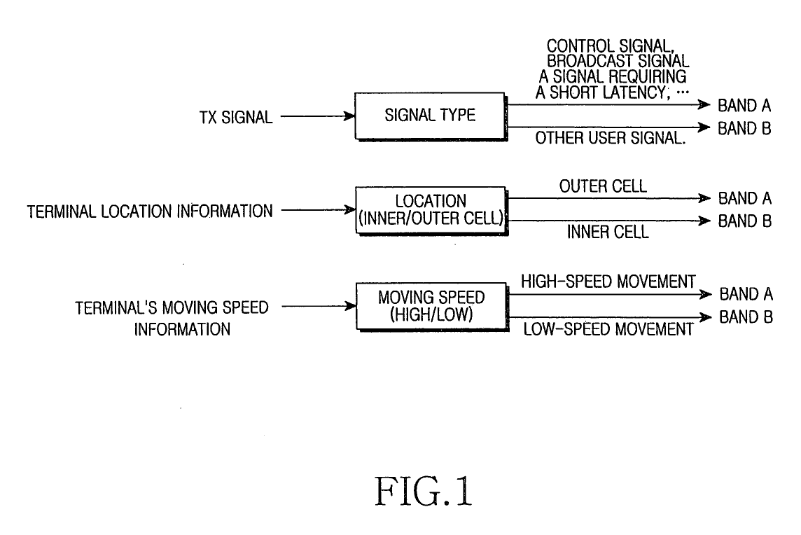

FIGS. 1 through 6C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide an apparatus and method for band allocation in a multi-band communication system.

Due to an increase in multimedia traffic, the next-generation system requires a wide band for supporting a high data rate. What is therefore being considered is a technique to maximize transmission efficiency by enabling one system to flexibly allocate resources to user terminals or a base station by means of multiple bands of different frequencies, and also the frequencies of the multiple bands are expected to be allocated after being divided into low frequency and high frequency that have different characteristics. In general, a low-frequency band has a wider coverage than a high-frequency band. That is, if a high-frequency band and a low-frequency band are transmitted at the same power and the same modulation and coding scheme (MCS) level, and if the percentage of user terminals, which has a performance lower than the minimum signal-to-interference and noise ratio (SINR) satisfying the lowest MCS level and thus is incapable of communication, is defined as an outage probability, the lower-frequency band has a lower outage probability than the high-frequency band.

Also, a difference in the outage probability between the low-frequency band and the high-frequency band increases greatly with an increase in cell radius. A user terminal must successfully receive a control signal transmitted by a base station, in order to be able to communicate with the base station. Thus, in most systems, a control signal of a base station is transmitted more robustly than a general data signal, an example of which is to transmit the control signal at an increased transmission (TX) power. However, due to a limit on the TX power, there is a limitation in extending the coverage by increasing the TX power. Also, if the control signal and the data signal are transmitted with resources allocated by Frequency Division Multiplexing (FDM), the TX power of the data signal decreases with an increase in the TX power of the control signal. It is practically difficult to transmit the control signal robustly at a further reduced MCS level for efficient resource management.

Thus, in order to reduce the outage probability of user terminals, i.e., to simultaneously achieve a high data rate and a coverage extension, the present invention provides: a method for allocating resources in a multi-band communication system in consideration of some or all of various conditions such as the characteristics of each band frequency, the type and transmission purpose of a user terminal signal, a required data rate, latency requirements, the location of a user terminal, the moving speed of a user terminal, and inter-frequency load balancing; a method for reducing an overhead when such multi-band MAP information is transmitted in a relatively low-frequency band among multiple bands; and a frame structure for enabling all the user terminals to operate efficiently when there is a mixture of user terminals capable of simultaneously decoding multiple bands and user terminals capable of decoding only one band. The present invention can be applied to an uplink (UL) and a downlink (DL) in the same manner.

In the following description, multiple bands are divided into a relatively high-frequency band and a relatively low-frequency band on the basis of a predetermined frequency. That is, multiple bands allocated to the system may be divided into a high-frequency band higher than a predetermined frequency and a low-frequency band lower than the predetermined frequency.

FIG. 1 is a diagram illustrating various band allocation conditions according to an embodiment of the present invention.

Referring to FIG. 1, considering the characteristics of each band frequency and the type and transmission purpose of a user terminal signal as a first band allocation condition, the present invention provides a method of allocating a band with wide coverage characteristics, i.e., a relatively low-frequency band among multiple bands, to signals requiring a wide coverage, such as control signals (e.g., broadcast channel (BCH) and MAP information), signals requiring a short latency (e.g., Voice over Internet Protocol (VoIP)), and broadcast signals, and preferentially allocating a relatively high-frequency band, which is expected to have a wider band than the relatively low-frequency band, to other user signals, thereby making it possible to provide a high data rate.

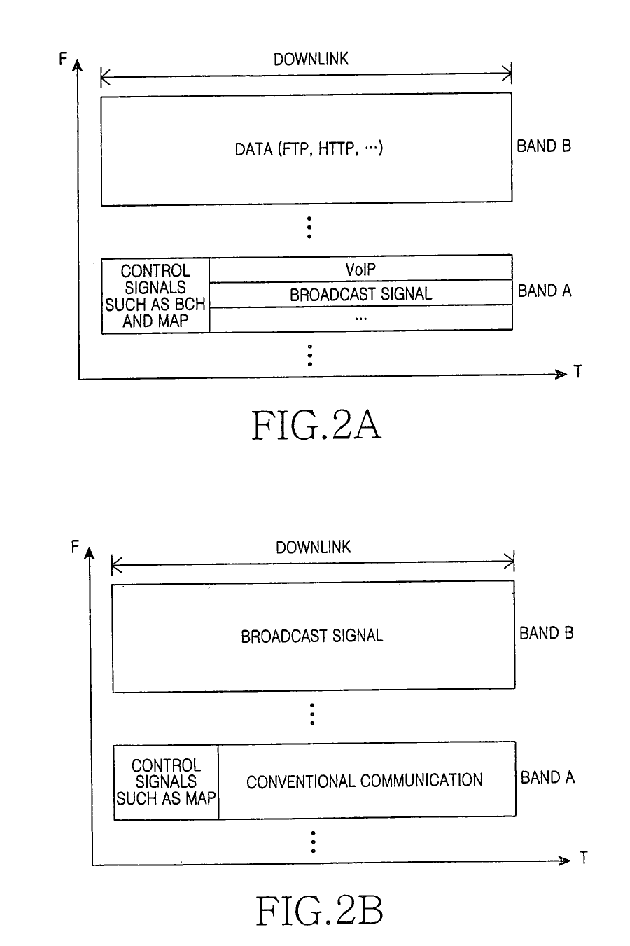

For example, as illustrated in FIGS. 2A and 2B, if a band A and a band B are used in one system, the bands are allocated in consideration of the frequency characteristics of each band frequency and the type and transmission purpose of a user terminal. To this end, a first method (FIG. 2A) transmits a control signal such as BCH and MAP information in a frame control region of the band A having lower frequencies than the band B, and allocates resources of the band A in order to support a broadcast service requiring a wide coverage and a VoIP service requiring a short latency. Herein, the control signal such as BCH and MAP information contains information about the entire band (i.e., the band A and the band B). The remaining band (i.e., the band B) except the band A is used to transmit user traffic data such as File Transfer Protocol (FTP) and Hyper Text Transfer Protocol (HTTP).

However, in this case, a user terminal capable of communication only in the band B cannot receive a control signal such as BCH and MAP information transmitted through the band A, and thus cannot communication with a base station. A control signal such as BCH and MAP information must be additionally transmitted in the band B so that the user terminal capable of communication only in the band B can communication with the base station. However, in this case, the control signal such as BCH and MAP information transmitted in the band B is transmitted only in a corresponding high-frequency band. In this way, if there are multiple bands, a relatively low-frequency band among the multiple bands is used to transmit a control signal such as BCH and MAP information, and a relatively high-frequency band is used to transmit data, thereby making it possible to increase the system throughput and reduce the outage probability of user terminals.

A second method (FIG. 2B) allocates resources of the band A to a communication signal and allocates resources of the band B to a broadcast signal. The broadcast signal is a special signal having only a downlink, the performance of which can be increased using a different technique than a general communication signal. For example, if all base stations use a single frequency network technique to transmit the same information in the same time and frequency, an inter-cell interference can be theoretically removed, thereby making it possible to increase the performance. To this end, because the length of a cyclic prefix (CP) of a broadcast signal must be sufficiently long and respective broadcast signal information must be transmitted in the same time and frequency in all cells, the broadcast signal need be designed differently from conventional communication signals (i.e., a variety of control and user signals for conventional communication). A method of effectively performing broadcast signal transmission and conventional general communication is to allocate a broadcast signal and a communication signal to different frequencies and design/manage them differently. Hereinafter, although the present invention will be described in terms of the first method (FIG. 2A), it may use the second method (FIG. 2B).

Using the frequency characteristics of each band and location information of a user terminal as a second band allocation condition, because a high-frequency band is shorter in communication distance than a low-frequency band, the present invention provides a method of allocating a relatively high-frequency band among multiple bands to a user terminal of an inner cell relatively near to a base station and preferentially allocating a relatively low-frequency band to a user terminal of an outer cell relatively distant from the base station. Examples of the location information of the user terminal include accurate user location data, which is obtained using a Global Positioning System (GPS), and the measured strength value of a signal received in a base station. Also, the average reception (RX) SINR of the user terminal may be used instead of the location information of the user terminal. In this case, if the average RX SINR value of the user terminal is smaller than a reference value, a relatively low-frequency band among multiple bands may be allocated; and if the average RX SINR value of the user terminal is greater than the reference value, a relatively high-frequency band among the multiple bands may be allocated.

Considering the frequency characteristics of each band and the moving speed of a user terminal as a third band allocation condition, the present invention provides a method of allocating a relatively low-frequency band among multiple bands to a high-mobility user terminal in order to reduce the performance degradation due to a time-dependent large channel change, and preferentially allocating a relatively high-frequency band among the multiple bands to a low-mobility user terminal. Herein, reference moving speeds for determination of band allocation according to the moving speed may be step-by-step values of, for example, 10 km/h, 30 km/h, 60 km/h and 120 km/h, which may be selected suitably according to whether the occupation band is full or not.

The band allocation may be performed by using the above three band allocation conditions in an independent manner or by using some or all of the above three band allocation conditions in a combined manner.

Although not illustrated, considering inter-frequency load balancing as a fourth band allocation condition, the present invention provides a method of allocating bands so that signals transmitted in respective bands are suitably distributed without being concentrated to only one band. The reference value in the above three band allocation conditions may be adjusted to achieve the load balancing effects.

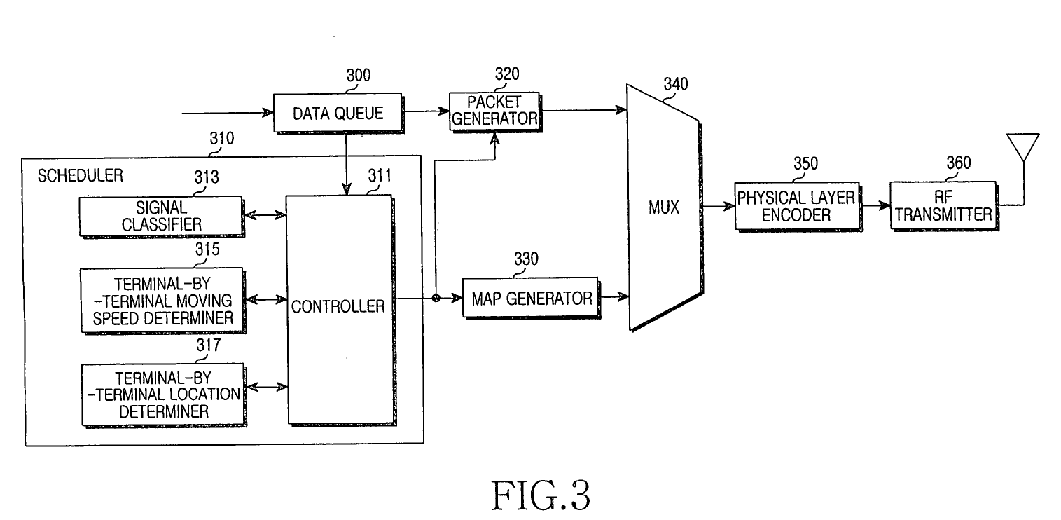

FIG. 3 is a block diagram of a base station in a multi-band communication system according to an embodiment of the present invention.

Referring to FIG. 3, the base station includes a data queue 300, a scheduler 310, a packet generator 320, a MAP generator 330, a multiplexer (MUX) 340, a physical layer encoder 350, and a radio frequency (RF) transmitter 360. The scheduler 310 includes a controller 311, a signal classifier 313, a terminal-by-terminal moving speed determiner 315, and a terminal-by-terminal location determiner 317.

The data queue 300 buffers and outputs TX signals (or service packets).

The scheduler 310 performs resource scheduling for input TX signals, which are received from the data queue 300, in consideration of some or all of various conditions such as the characteristics of each band frequency, the type and transmission purpose of a user terminal signal, a required data rate, latency requirements, the location of a user terminal, the moving speed of a user terminal, and inter-frequency load balancing, and outputs the scheduling results to the packet generator 320 and the MAP generator 330.

Specifically, the controller 311 of the scheduler 310 outputs input TX signals to the signal classifier 313, receives classified TX signals (e.g., a control signal, a broadcast signal, a signal requiring a short latency, and other user signals) from the signal classifier 313, and allocates a relatively low-frequency band among multiple bands to the TX signals classified as the control signal, the broadcast signal, and the signal requiring a short latency. Thereafter, the controller 311 outputs the TX signals classified as the other user signals to the terminal-by-terminal moving speed determiner 315, receives TX signals classified according to the moving speed of a user terminal from the terminal-by-terminal moving speed determiner 315, and allocates a relatively low-frequency band among the multiple bands to a TX signal among the other user signals, the user terminal moving speed of which is classified as being greater than a threshold value. Thereafter, the controller 311 outputs a TX signal among the other user signals, the user terminal moving speed of which is classified as being smaller than or equal to the threshold value, to the terminal-by-terminal location determiner 317, receives TX signals classified according to the location of a user terminal from the terminal-by-terminal location determiner 317, allocates a relatively low-frequency band among the multiple bands to a TX signal of an outer cell user terminal, and allocates a relatively high-frequency band among the multiple bands to a TX signal of an inner cell user terminal. Also, in consideration of inter-frequency load balancing, the controller 311 performs load balancing during or after a scheduling operation so that signals transmitted in respective bands are suitably distributed without being concentrated to only one band. Herein, the load balancing may be performed by changing the classification conditions of one or more of the above three TX signal classification methods and reallocating bands according to the changed classification conditions.

Herein, the signal classifier 313 classifies TX signals according to the signal types and transmission purposes. For example, the signal classifier 313 classifies TX signals into a control signal (including BCH and MAP information), a broadcast signal, a signal requiring a short latency, and other user signals. Also, the terminal-by-terminal moving speed determiner 315 classifies TX signals according to the moving speed of a user terminal that is to receive a corresponding signal. That is, the TX signals are classified into a TX signal, the user terminal moving speed of which is greater than a threshold value, and a TX signal, the user terminal moving speed of which is smaller than or equal to the threshold value. The terminal-by-terminal location determiner 317 classifies TX signals according to the location of a user terminal that is to receive a corresponding signal. That is, the TX signals are classified into a TX signal, the user terminal of which is an outer cell user terminal, and a TX signal, the user terminal of which is an inner cell user terminal.

According to the scheduling results received from the scheduler 310, the packet generator 320 generates and outputs the TX signals received from the data queue 300 as a predetermined packet (e.g., MAC PDU). Using the scheduling results received from the scheduler 310, the MAP generator 330 generates and outputs MAP information (or resource allocation information) transmitted through a control region of a frame.

According to a predetermined rule, the multiplexer 340 selects and outputs packets received from the packet generator 320 and the MAP generator 330. For example, the multiplexer 340 selects and outputs the output of the MAP generator 330 at the start of a frame, and then selects and outputs packets received from the packet generator 320 in a downlink interval.

Upon start of a frame, the physical layer encoder 350 generates and outputs a preamble signal transmitted at the start of the frame, and then physical-layer-encodes packets received from the multiplexer 340. Herein, the physical layer encoder 350 may include a channel encoding block and a modulation block. In the case of an Orthogonal Frequency Division Multiplexing (OFDM) system, the channel encoding block may include a channel encoder, an interleaver, and a modulator, and the modulation block may include an Inverse Fast Fourier Transform (IFFT) processor for loading TX data on a plurality of orthogonal subcarriers.

The RF transmitter 360 converts a baseband digital signal received from the physical layer encoder 350 into an analog signal, and converts the baseband analog signal into a radio frequency (RF) signal prior to transmission through an antenna.

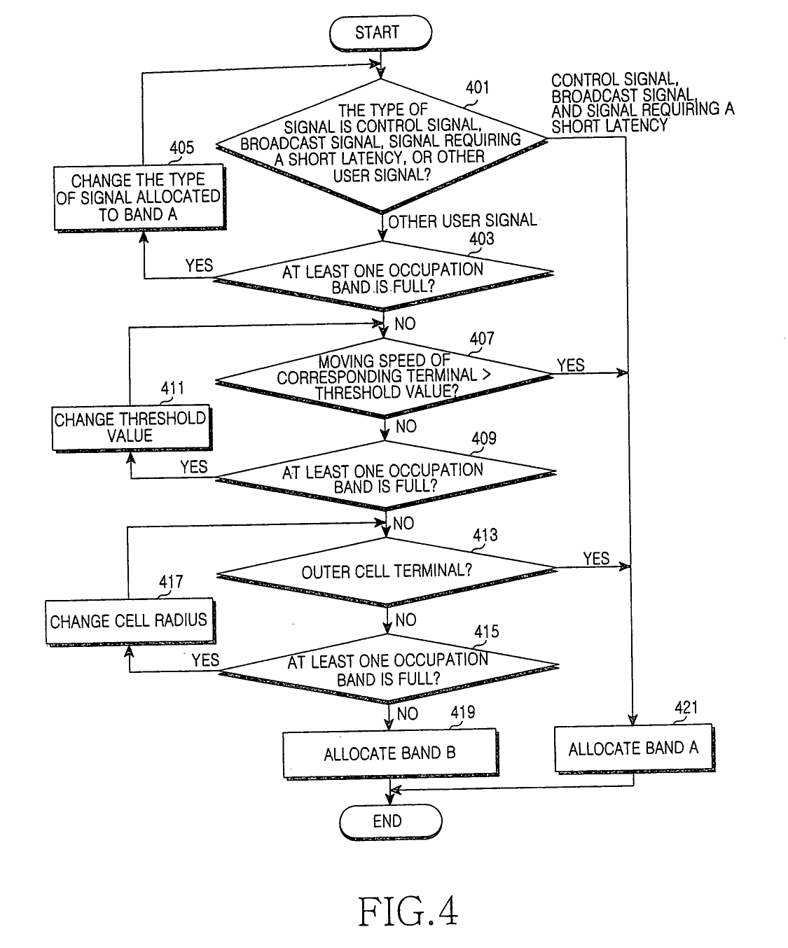

FIG. 4 is a flow diagram illustrating a band allocation scheduling method of a scheduler in a multi-band communication system according to an embodiment of the present invention.

Referring to FIG. 4, in step 401, the scheduler classifies TX signals according to the signal types and transmission purposes in order to allocate resources to TX signals by considering the signal types and transmission purposes as a first band allocation condition. That is, the scheduler classifies TX signals into a control signal (including BCH and MAP information), a broadcast signal, a signal requiring a short latency, and other user signal. To this end, the scheduler determines whether the type of a TX signal is a control signal, a broadcast signal, a signal requiring a short latency, or other user signal. In step 421, the scheduler allocates a relatively low-frequency band (i.e., the band A in FIGS. 2A and 2B) among multiple bands to the TX signal classified as a control signal, a broadcast signal, or a signal requiring a short latency in step 401.

In step 403, the scheduler determines whether at least one occupation band of the TX signal classified as other user signal in step 401 is full. That is, the scheduler determines whether all the resources are allocated to at least one of a relatively low-frequency band and a relatively high-frequency band among the multiple bands and thus resource allocation is not possible any more. If at least one occupation band is full, the scheduler changes the TX signal classification criterion in step 405 (i.e., changes the type of a signal allocated to a low-frequency band) and returns to step 401 to classify the TX signals according to the changed TX signal classification criterion, thereby reallocating bands to the TX signals.

Herein, various embodiments are possible for the TX signal classification criterion changing method. For example, signals requiring a short latency may be classified into a signal requiring a relatively short latency and a signal requiring a relatively long latency. In this case, the scheduler may allocate a signal requiring a relatively short latency to a relatively low-frequency band among multiple bands and may allocate a signal requiring a relatively long latency to a relatively high-frequency band among the multiple bands.

If any occupation band is not full in step 403, the scheduler classifies TX signals according to the moving speed of a user terminal, which is to receive the corresponding signal, in order to allocate resources to TX signals by considering the moving speed of the corresponding terminal as a second band allocation condition, in step 407. That is, the scheduler classifies TX signals into a TX signal, the user terminal moving speed of which is greater than a threshold value, and a TX signal, the user terminal moving speed of which is smaller than or equal to the threshold value. To this end, the scheduler determines whether the moving speed of the corresponding terminal for each TX signal is greater than a threshold value. Herein, the moving speed of the terminal may be a value estimated using location information measured by a GPS, a value obtained by estimating a Doppler frequency in a signal received from the terminal, or one or a combination of values measured by various methods. In step 421, the scheduler allocates a relatively low-frequency band (i.e., the band A in FIGS. 2A and 2B) among multiple bands to the TX signal, the user terminal moving speed of which is classified as being greater than the threshold value in step 407.

In step 409, the scheduler determines whether at least one occupation band of the TX signal, the user terminal moving speed of which is classified as being smaller than or equal to than the threshold value in step 407, is full. If at least one occupation band is full, the scheduler changes the threshold value in step 411 and returns to step 407 to classify the TX signals according to the changed threshold value, thereby reallocating bands to the TX signals. Herein, the threshold value may be a variety of step-by-step values. For example, if all the resources are allocated to a low-frequency band and thus resource allocation is not possible any more, the threshold value may be increased by one step; and if all the resources are allocated to a high-frequency band and thus resource allocation is not possible any more, the threshold value may be decreased by one step.

If any occupation band is not full in step 409, the scheduler classifies TX signals into a signal of a user terminal located within a reference distance from a base station and a signal of a user terminal located outside the reference distance from the base station, in order to allocate resources to TX signals by considering the location of the corresponding terminal as a third band allocation condition, in step 413. That is, the scheduler classifies TX signals a TX signal, the user terminal of which is an outer cell user terminal, and a TX signal, the user terminal of which is an inner cell user terminal. To this end, the scheduler determines whether the corresponding terminal for each TX signal is an outer cell user terminal. Herein, the location information of the terminal may be a value measured by a GPS, a value estimated using the strength of a signal received from the terminal (e.g., the average RX SINR value), or one or a combination of values measured by other various methods. Herein, if the average RX SINR value is used, the scheduler may classify the TX signals into a signal of a user terminal having the average RX SINR value greater than a reference value and a signal of a user terminal having the average RX SINR value smaller than the reference value.

In step 421, the scheduler allocates a relatively low-frequency band (i.e., the band A in FIGS. 2A and 2B) among multiple bands to the TX signal, the corresponding terminal of which is classified as an outer cell terminal in step 413.

In step 415, the scheduler determines whether at least one occupation band of the TX signal, the corresponding terminal of which is classified as an inner cell terminal in step 413, is full. If at least one occupation band is full, the scheduler changes a cell radius in step 417 and returns to step 413 to classify the TX signals according to the changed cell radius, thereby reallocating bands to the TX signals. Herein, the cell radius may be a variety of step-by-step values. For example, if all the resources are allocated to a relatively low-frequency band among multiple bands and thus resource allocation is not possible any more, the cell radius may be increased by one step; and if all the resources are allocated to a relatively high-frequency band among the multiple bands and thus resource allocation is not possible any more, the cell radius may be decreased by one step.

If any occupation band is not full in step 415, the scheduler allocates a relatively high-frequency band (i.e., the band B in FIGS. 2A and 2B) among multiple bands to the TX signal, the corresponding terminal of which is classified as an inner cell terminal, in step 419.

Thereafter, the scheduler ends the algorithm according to the present invention.

Meanwhile, although FIG. 4 has exemplified a method of performing a load balancing operation during a scheduling operation (steps 403, 409 and 415 and corresponding steps 405, 411 and 417) by considering inter-frequency balancing as a fourth band allocation condition so that signals transmitted in respective bands are suitably distributed without being concentrated to only one band, the load balancing operation may be performed after the scheduling operation. That is, after completion of the scheduling operation, the scheduler determines in step 415 whether at least one occupation band is full. Thereafter, if any occupation band is not full, the scheduler allocates in step 419 a relatively high-frequency band among multiple bands to a TX signal, the corresponding terminal of which is classified as an inner cell terminal; and if at least one occupation band is full, the scheduler changes the condition through at least one of steps 405, 411 and 417 and reallocates bands according to the changed condition.

Meanwhile, if a single band is allocated to an uplink and a downlink as in the conventional system, resource allocation information in the single band is transmitted through a MAP region. Thus, MAP information can be transmitted in each band even when multiple bands are allocated. However, if the information is transmitted in this method, a MAP overhead increases and each user terminal must decode MAP information in all the bands. In this case, there is no problem in a user terminal capable of simultaneously decoding multiple bands, but a conventional user terminal capable of decoding only one band fails to receive the MAP information. Also, for coverage extension, as in the embodiment according to the present invention, if a low-frequency band among multiple bands is used to transmit signals that is to be transmitted to all the user terminals, e.g., control signals such as BCH and MAP information, resource allocation information for all the bands for all the user terminals must be transmitted in the format of a single MAP, thus increasing a MAP overhead. What is therefore required is to simplify resource indexing unlike the conventional single band in order to reduce the MAP overhead.

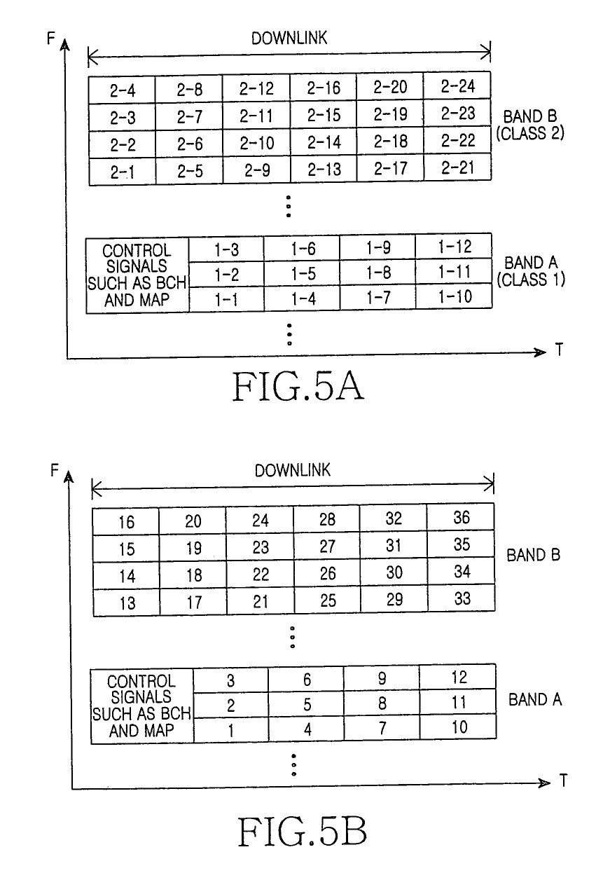

FIGS. 5A and 5B are diagrams illustrating a resource indexing method for reducing a MAP overhead in a multi-band communication system according to an embodiment of the present invention.

Referring to FIGS. 5A and 5B, in the case of FIG. 5A, band indexes are given in order for respective bands of the system, for example, class 1 and class 2, and then a resource index is given to each resource in each band (or class). In this case, the two types of indexes are transmitted to a user terminal through a control region of a frame. In the case of FIG. 5B, band indexes are not given to respective bands of the system, but band indexes are consecutively given to respective resources in all the bands. In this case, only the resource index is transmitted to a user terminal through a control region of a frame.

Meanwhile, the present invention assumes that multiple bands are operated in one system unlike the conventional band allocation. In the next-generation system, it is expected that such multiple bands will be generally used. Thus, it is expected that a user terminal supporting such multiple bands will be developed. However, there is a possibility that there is a user terminal that can transmit or receive signals through only one band at one time, failing to transmit or receive signals simultaneously in multiple bands like the conventional system terminal. What is therefore required is a frame structure that can efficiently support both a user terminal capable of receiving signals simultaneously in multiple bands and a user terminal capable of receiving a signal in only one band at one time.

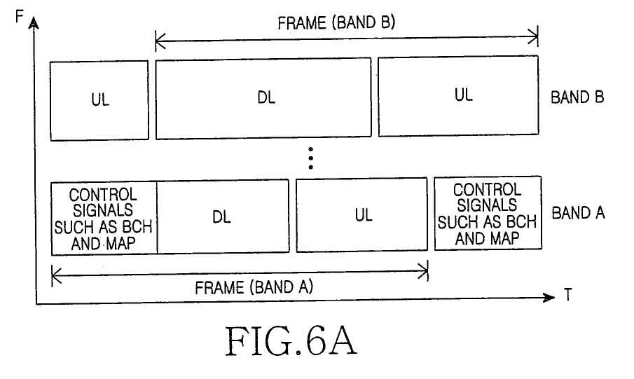

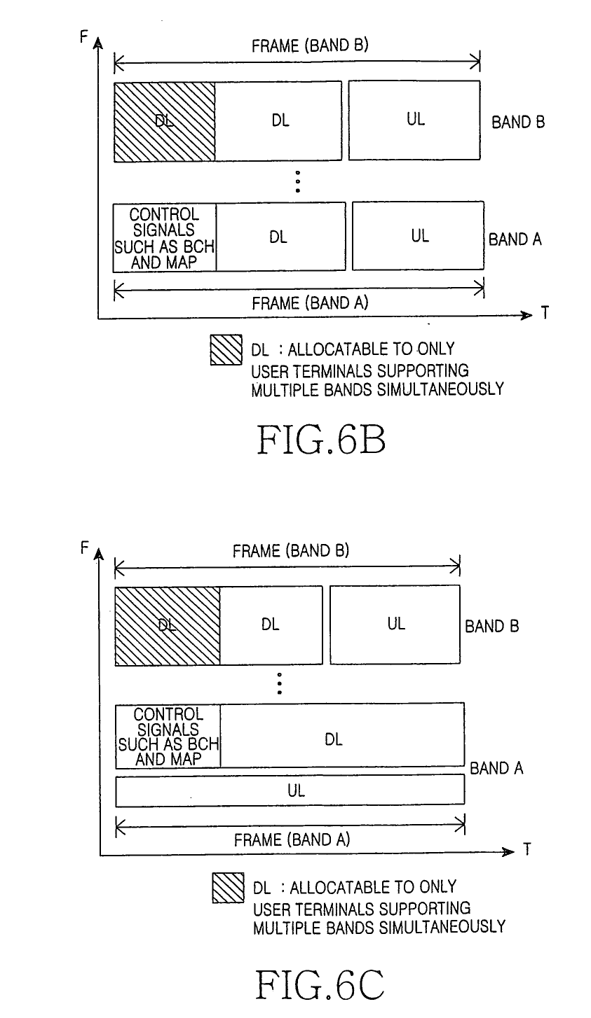

FIGS. 6A, 6B and 6C are diagrams illustrating a frame structure designing method considering the capability of a user terminal in a multi-band communication system according to an embodiment of the present invention.

Referring to FIGS. 6A, 6B and 6C, FIG. 6A illustrates a Time Division Duplex (TDD) frame structure where the start point of a band A (i.e., a relatively low-frequency band among multiple bands) and the start point of a band B (i.e., a relatively high-frequency band among the multiple bands) are set differently. Herein, the frame of the band A includes: a control region for transmitting control signals such as BCH and MAP information; a downlink data region; and an uplink data region, while the frame of the band B includes a downlink data region and an uplink data region. Herein, the start point of the band B is set to be the end of the control region in the frame of the band A.

FIG. 6B illustrates a TDD frame structure where the start point of a band A and the start point of a band B are set identically. Herein, the frame of the band A includes: a control region for transmitting control signals such as BCH and MAP information; a downlink data region; and an uplink data region, while the frame of the band B includes a downlink data region and an uplink data region. Herein, during the time region for transmitting a control signal, that is to be received by all the user terminals, in the band A, resources of the band B for transmitting downlink data are allocated to only user terminals capable of supporting multiple bands simultaneously.

FIG. 6C illustrates a Frequency Division Duplex (FDD) frame structure. Herein, the frame structure is the same as in FIG. 6B with the exception that the band A has an FDD frame structure. Herein, although it has been illustrated that only one of the band A and the band B has an FDD frame structure and the other has a TDD frame structure, both of the two bands may have an FDD frame structure.

As described above, the present invention allocates resources in the multi-band communication system in consideration of some or all of various conditions such as the characteristics of each band frequency, the type and transmission purpose of a user terminal signal, a required data rate, latency requirements, the location of a user terminal, the moving speed of a user terminal, and inter-frequency load balancing, thereby making it possible to achieve a high data rate and a coverage extension. Also, it is possible to reduce the costs because the number of base stations is reduced due to the coverage extension. Also, it is possible to satisfy the QoS of a user terminal, increase the system throughput, and reduce the outage probability of a user terminal. Also, the present invention provides the frame structure that uses the resource indexing simplifying method to reduce a MAP overhead when MAP information of multiple bands is transmitted in a relatively low-frequency band among the multiple bands, and enables all the user terminals to operate efficiently in a multi-band communication system when there is a mixture of user terminals capable of simultaneously decoding multiple bands and user terminals capable of decoding only one band, thereby making it possible to efficiently allocate resources to the two types of user terminals.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for allocating bands in a multi-band communication system, the method comprising:
classifying transmission (TX) signals into at least one of a control signal, a broadcast signal and a signal requiring a short latency, and other user signal in consideration of the types of the TX signals;
allocating a band of a frequency lower than a reference frequency among the multiple bands to a signal classified as at least one of the control signal, the broadcast signal and the signal requiring a short latency; and
allocating a band of a frequency higher than the reference frequency to a signal classified as the other user signal.

2. The method of claim 1, wherein the classifying of the TX signals comprises classifying the TX signals by considering at least one of a characteristics of each band frequency, a type and a transmission purpose of the TX signal, a required data rate, a latency requirements, a location of a user terminal, a moving speed of a user terminal, and an inter-frequency load balancing.

3. The method of claim 2, wherein the classifying of the TX signals in consideration of the location of a user terminal comprises classifying the TX signals into a signal of a user terminal located within a reference distance from a base station and a signal of a user terminal located outside the reference distance from the base station.

4. The method of claim 3, further comprising:
allocating the band of the frequency higher than the reference frequency among the multiple bands to the signal of the user terminal located within the reference distance from the base station; and
allocating the band of the frequency lower than the reference frequency to the signal of the user terminal located outside the reference distance from the base station.

5. The method of claim 2, wherein the classifying of the TX signals by considering the location of a user terminal comprises classifying the TX signals as a signal of a user terminal having an average receive (RX) signal to interference and noise ratio (SINR) value greater than a reference value and a signal of a user terminal having an average RX SINR value smaller than the reference value.

6. The method of claim 5, further comprising:
allocating the band of the frequency higher than the reference frequency among the multiple bands to the signal of the user terminal having an average RX SINR value greater than the reference value; and
allocating the band of the frequency lower than the reference frequency to the signal of the user terminal having an average RX SINR value smaller than the reference value.

7. The method of claim 2, wherein the classifying of the TX signals by considering the moving speed of a user terminal comprises classifying the TX signals as a signal of a user terminal having a moving speed higher than a reference speed and a signal of a user terminal having a moving speed lower than the reference speed.

8. The method of claim 7, further comprising:
allocating the band of the frequency lower than the reference frequency among the multiple bands to the signal of the user terminal having a moving speed higher than the reference speed; and
allocating the band of the frequency higher than the reference frequency to the signal of the user terminal having a moving speed lower than the reference speed.

9. The method of claim 2, wherein if there are two or more consideration conditions for classification of the TX signals, the classifying of the TX signals and the allocating of the bands comprises:
applying priorities to the two or more consideration conditions and classifying the TX signals according to the consideration condition having the highest priority;
allocating a band of a frequency lower than the reference frequency to signals classified according to the consideration condition having the highest priority;
classifying signals according to the consideration condition having the next highest priority, with respect to signals failing to be allocated the band of the frequency lower than the reference frequency, among the signals classified according to the consideration condition having the highest priority;
allocating a band of a frequency lower than the reference frequency to signals classified according to the consideration condition having the next highest priority; and
upon completion of the classification of the TX signals and the allocation of the band of the frequency lower than the reference frequency according to all the consideration conditions, allocating a band of a frequency higher than the reference frequency to the signal failing to be allocated the band of the frequency lower than the reference frequency.

10. The method of claim 1, wherein the reference value for the TX signal classification is adjusted so that the band allocation of the TX signals is suitably distributed to all the bands.

11. An apparatus for allocating bands in a multi-band communication system, the apparatus comprising:
a scheduler for classifying transmission (TX) signals into at least one of a control signal, a broadcast signal and a signal requiring a short latency, and other user signal in consideration of the types of the TX signals, allocating a band of a frequency lower than a reference frequency among the multiple bands to a signal classified as at least one of the control signal, the broadcast signal and the signal requiring a short latency, and allocating a band of a frequency higher than the reference frequency to a signal classified as the other user signal; and
a MAP generator for generating a MAP information containing the band allocation results.

12. The apparatus of claim 11, wherein the scheduler classifies the TX signals by considering at least one of a characteristics of each band frequency, a type and a transmission purpose of the TX signal, a required data rate, a latency requirements, a location of a user terminal, a moving speed of a user terminal, and an inter-frequency load balancing.

13. The apparatus of claim 12, wherein if the TX signals are classified in consideration of the location of a user terminal, the scheduler classifies the TX signals into a signal of a user terminal located within a reference distance from a base station and a signal of a user terminal located outside the reference distance from the base station.

14. The apparatus of claim 13, whether in the scheduler allocates the band of the frequency higher than the reference frequency among the multiple bands to the signal of the user terminal located within the reference distance from the base station, and allocates the band of the frequency lower than the reference frequency to the signal of the user terminal located outside the reference distance from the base station.

15. The apparatus of claim 12, wherein if the TX signals are classified by considering the location of a user terminal, the scheduler classifies the TX signals as a signal of a user terminal having an average receive signal to interference and noise ratio (RX SINR) value greater than a reference value and a signal of a user terminal having an average RX SINR value smaller than the reference value.

16. The apparatus of claim 15, wherein the scheduler allocates the band of the frequency higher than the reference frequency among the multiple bands to the signal of the user terminal having the average RX SINR value greater than the reference value, and allocates the band of the frequency lower than the reference frequency to the signal of the user terminal having the average RX SINR value smaller than the reference value.

17. The apparatus of claim 12, wherein if the TX signals are classified by considering the moving speed of a user terminal, the scheduler classifies the TX signals as a signal of a user terminal having a moving speed higher than a reference speed and a signal of a user terminal having a moving speed lower than the reference speed.

18. The apparatus of claim 17, wherein the scheduler allocates the band of the frequency lower than the reference frequency among the multiple bands to the signal of the user terminal having a moving speed higher than the reference speed, and allocates the band of the frequency higher than the reference frequency to the signal of the user terminal having a moving speed lower than the reference speed.

19. The apparatus of claim 12, wherein if there are two or more consideration conditions for classification of the TX signals, the scheduler applies priorities to the two or more consideration conditions, classifies the TX signals according to the consideration condition having the highest priority, allocates a band of a frequency lower than the reference frequency to signals classified according to the consideration condition having the highest priority, classifies signals according to the consideration condition having the next highest priority, with respect to signals failing to be allocated the band of the frequency lower than the reference frequency, among the signals classified according to the consideration condition having the highest priority, allocates a band of a frequency lower than the reference frequency to signals classified according to the consideration condition having the next highest priority, and upon completion of the classification of the TX signals and the allocation of the band of the frequency lower than the reference frequency according to all the consideration conditions, allocates a band of a frequency higher than the reference frequency to the signal failing to be allocated the band of the frequency lower than the reference frequency.

20. The apparatus of claim 11, wherein the scheduler adjusts the reference value for the TX signal classification so that the band allocation of the TX signals is suitably distributed to all the bands.

21. A method for resource indexing in a multi-band communication system, the method comprising:
giving a band index to each band;
giving resource indexes to the entire resources in the corresponding band on a band-by-band basis; and
transmitting at least one of the resource index and the band index of the corresponding resource to a user terminal allocated the resource.

22. The method of claim 21, whether at least one of the resource index and the band index of the corresponding resource is transmitted through a control region of a frame.

23. The method of claim 21, whether the resource indexes are given on a step-by-step basis.

24. A method for resource indexing in a multi-band communication system, comprising:
giving resource indexes to the entire resources in multiple bands on a step-by-step basis; and
transmitting the resource index of the corresponding resource to a user terminal allocated the resource.

25. The method of claim 24, whether the resource index of the corresponding resource is transmitted through a control region of a frame.

26. A frame structure for a multi-band communication system where there is a mixture of user terminals a single band and user terminals supporting multiple bands simultaneously, the frame structure comprising:
a frame of a band of a frequency lower than a reference frequency among the multiple bands, the lower-frequency band frame including at least one of a control signal region, a downlink data region and an uplink data region; and
a frame of a band of a frequency higher than the reference frequency among the multiple bands, the higher-frequency band frame including at least one of a downlink data region and an uplink data region,
wherein resources of the higher-frequency band frame are transmitted to only user terminals simultaneously supporting multiple bands in the same time interval when signals are transmitted through the control signal region of the lower-frequency band frame.

27. The frame structure of claim 26, wherein the start points of the two frames are different or identical.

28. The frame structure of claim 27, wherein if the start points of the two frames are different, the start point of the higher-frequency band frame is the end point of the control region in the lower-frequency band frame.

29. The frame structure of claim 26, wherein at least one of the two frames has a Frequency Division Duplex (FDD) frame structure or a Time Division Duplex (TDD) frame structure.

30. A frame structure for a multi-band communication system where there is a mixture of user terminals a single band and user terminals supporting multiple bands simultaneously, the frame structure comprising:
a frame of a band of a frequency lower than a reference frequency among the multiple bands, the lower-frequency band frame including at least one of a control signal region, a downlink data region and an uplink data region; and
a frame of a band of a frequency higher than the reference frequency among the multiple bands, the higher-frequency band frame including at least one of a downlink data region and an uplink data region,
wherein all or some of the uplink data region of the higher-frequency band frame are located in the same time interval when signals are transmitted through the control signal region of the lower-frequency band frame.

31. The frame structure of claim 30, wherein if the start points of the two frames are different, the start point of the higher-frequency band frame is the end point of the control region in the lower-frequency band frame.
